(19) United States
(12) Patent Application Publication
(10) Pub. No.: US 2026/0179831 A1
(43) Pub. Date: Jun. 25, 2026

(54) Low Common-Mode Noise Planar Transformer

(71) Applicant: NATIONAL INSTRUMENTS CORPORATION, Austin, TX (US)

(72) Inventor: Matthew Tate Dougan, Austin, TX (US)

(21) Appl. No.: 18/987,539

(22) Filed: Dec. 19, 2024

(51) Int. Cl. H01F 27/36; H01F 30/06

(52) U.S. Cl. CPC H01F 27/363; H01F 30/06

(57) ABSTRACT

A planar transformer includes a core, a first circuit, a second circuit, and a primary conductive shield. The first circuit includes two or more primary windings that are stacked in two or more layers and are magnetically coupled to the core. The second circuit includes a rectifier circuit and two or more secondary windings that are magnetically coupled to the core. The primary conductive shield is stacked between a first primary winding of the two or more primary windings and a first secondary winding of the two or more secondary windings. The primary conductive shield reduces a capacitive coupling between the first primary winding and the first secondary winding.

### BACKGROUND

Transformers are widely used in industry to transfer electrical signals between circuits, often modifying the signal in some desired manner in the process. It is desirable for a transformer circuit design to have a linear response with low noise and strong coupling between the two sets of windings, while also having a relatively inexpensive construction cost. Undesirably large noise levels from current transformer circuit designs incur substantial costs to the performance and efficiency of electronic circuits. Accordingly, improvements in the field are desirable.

### SUMMARY

Described herein are embodiments relating to designs and architectures for a planar transformer.

In some embodiments, a planar transformer includes a core, a first circuit, a second circuit, and a primary conductive shield. In some embodiments, the first circuit includes two or more primary windings that are stacked in two or more layers and are magnetically coupled to the core.

In some embodiments, the second circuit includes a rectifier circuit and two or more secondary windings that are magnetically coupled to the core.

In some embodiments, the primary conductive shield may be stacked between a first primary winding of the two or more primary windings and a first secondary winding of the two or more secondary windings. The primary conductive shield reduces a capacitive coupling between the first primary winding and the first secondary winding.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present disclosure can be obtained when the

following detailed description is considered in conjunction with the following drawings, in which:

FIG. 1 illustrates a top-down physical view of a 3:5 transformer architecture, according to some embodiments;

FIG. 2 illustrates the circuit connections between the primary and secondary windings for the architecture shown in FIG. 1, according to some embodiments;

FIGS. 3A-D illustrate circuit aspects of a 2:3 planar transformer, according to some embodiments;

FIGS. 4A-D illustrate circuit aspects of a 1:1 planar transformer, according to some embodiments;

FIGS. 5A-D illustrate circuit aspects of a 1:2 planar transformer, according to some embodiments;

FIGS. 6A-C illustrate circuit aspects of a 3:1 planar transformer, according to some embodiments;

FIGS. 7A-B illustrate voltage profiles for different orientations of secondary and shield windings, according to some embodiments; and

FIGS. 8A-K illustrate detailed physical aspects of a 2:3 planar transformer design, according to some embodiments.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but on the contrary, the intention is to cover all modifications, equivalents, and alternatives falling within the spirit and scope of the present disclosure as defined by the appended claims. It is noted that the word “may” is used throughout this application in a permissive sense (e.g., having the potential to, being able to), not a mandatory sense (e.g., must).

### DETAILED DESCRIPTION

In the following description, numerous specific details are set forth to provide a thorough understanding of embodiments of the present disclosure. However, one having ordinary skill in the art should recognize that the disclosure may be practiced without these specific details. In some instances, well-known circuits, structures, and techniques have not been shown in detail to avoid obscuring the present disclosure.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

### Terms

The following is a glossary of terms used in the present application:

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually,” wherein the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism,” where the tasks are performed in an interleaved manner, e.g., by time multiplexing of execution threads.

Approximately—refers to a value being within some specified tolerance or acceptable margin of error or uncertainty of a target value, where the specific tolerance or margin is generally dependent on the application. Thus, for example, in various applications or embodiments, the term approximately may mean: within 0.1% of the target value, within 0.2% of the target value, within 0.5% of the target value, within 1%, 2%, 5%, or 10% of the target value, and so forth, as required by the particular application of the present techniques.

### Detailed Description

Embodiments herein describe repeatable, high performance and low noise switch-mode power supply transformers. The described transformer architectures may provide for superior power isolation in power supplies, source-measure units (SMUs), dynamic memory management (DMM) devices, and other test and measurement products. However, the described embodiments can be generally applicable for any isolated power converter application. For commercial or industrial use cases, the natively low noise profile provided by described embodiments may eliminate or reduce expensive and bulky filtering stages, and/or simplify transformer assembly.

Existing low common mode noise transformers have taken a variety of approaches, such as incorporating an increased distance between the primary and secondary windings, which directly trades off increased leakage inductance for low capacitance. These approaches have the disadvantage that they are unable to optimize both leakage inductance and low capacitance at the same time.

Common-mode noise is frequently an issue in isolated power conversion, commonly done with galvanically isolated transformers. While the magnetic coupling of the primary and secondary windings is desired, capacitive coupling between the primary and secondary windings is not. This interwinding capacitance leads to a noise current that flows across the isolation barrier, generated by the voltage swings of the primary or secondary winding. It may be especially troublesome in high-voltage or high-frequency converters. This noise current has a return path across the isolation barrier, and external capacitance across the isolation barrier may be utilized to filter it locally. However, even with this, some of this common-mode noise current will flow out through external cabling and devices—causing test & measurement issues, conducted emissions issues, and/or radiated emissions issues.

Capacitive coupling between windings may lead to undesirable noise, and planar transformers may suffer from capacitive coupling more than other designs, such as wire-and-bobbin transformers. They may also have worse native AC resistance. Interleaving may be used to mitigate this native resistance, which may increase interwinding capacitance even further.

There are two different types of capacitive coupling intra-winding capacitance (between two primary windings or two secondary windings) and inter-winding capacitance (between a primary winding and a secondary winding). Both types are desirable to lower or remove, although inter-winding capacitance is usually a more significant source of noise. Intra-winding capacitance may reduce the self-resonant frequency of the transformer, which may cause problems for some power stages.

Previous transformer designs have utilized both wire-and-bobbin and planar formats, with some key deficiencies. In wire-and-bobbin constructions, common issues involve manufacturability and repeatability of capacitive noise. In planar constructions, repeatability is better, but capacitive coupling is generally worse. Shielding may be used to decrease capacitive coupling, which introduces a shield winding next to a primary and/or secondary winding, where the shield winding is connected to ground. Shielded approaches often utilize two shields (primary ground and secondary ground). How well these are terminated and overlap with each other determines the level of noise reduction achieved. In double shielded planar approaches, one issue that arises is that the shield turns tend to take an open ‘C’ shape—and the primary/secondary C shapes are complementary/mirror images. This leads to fringing effects, and significant circulating current that degrades effectiveness. Termination of the shield is especially problematic in wire-and-bobbin formats, limiting effectiveness with increased operating frequency due to termination inductance. The shield is also a ‘dead’ layer that will add additional power loss via eddy currents if its thickness is not kept very thin.

Some bootstrapped approaches may be shieldless, but they rely on knowing the exact power topology and finding windings with potentials that match each other. As used herein, “bootstrapping” in the context of transformer design refers to putting windings with similar voltage swings next to each other, to minimize noise current flowing through capacitive displacement current. This restricts the approach to a smaller subset of power topologies. Additionally, the windings may still have a ‘complementary’ or ‘rotated’ shape from each other (primary to secondary), leading to circulating currents. Embodiments herein address these and other concerns by implementing a half-shielded and half-bootstrapped approach for a planar transformer, as described in greater detail below.

### Half-Shield and Half-Bootstrapped Transformer Design

Embodiments herein implement a half-shielded and half-bootstrapped approach for a planar transformer. Advantageously, the described embodiments reduce the number of copper layers in the transformer circuit. Previous implementations that utilize both a primary shield layer and a secondary shield layer have a larger overall transformer thickness, whereas the described embodiments utilize only a single shield layer in combination with the bootstrapping effectuated by a rectifier circuit. The described embodiments allow the transformer to be flexible with great performance for a wide range of topologies. In the following description, embodiments are described where the primary winding is shielded and the secondary winding is bootstrapped. However, it is within the scope of the present disclosure to implement an inverse arrangement, where the primary winding is bootstrapped and the secondary winding is shielded.

In some embodiments, a shield winding is inserted at an interleaving boundary between primary and secondary windings. Interleaving refers to the alternation between primary and secondary windings in the transformer stack. Interleaving the primary and secondary windings may advantageously reduce the accumulated magnetic flux magnitude, which accumulates with each subsequent stacked winding of the same type. For example, having five secondary windings stacked would lead to an accumulated flux magnitude that is 5 times the magnitude of a single secondary winding. On the other hand, interleaving primary and secondary windings reduces this voltage magnitude, as the primary and secondary windings accumulate flux in opposite directions, reducing the magnetic strain on the transformer, decreasing the proximity effect, and decreasing AC resistance. The benefits of interleaving (reduced accumulated flux and reduced AC resistance) may be balanced against the undesirable increased inter-winding capacitive coupling that occurs between adjacent primary and secondary windings. In some embodiments, the degree of interleaving implemented in the transformer circuit design may be determined to balance these two considerations and provide improved or optimal performance.

The shield winding is typically an ‘open C’ shape, or a winding with a small slit in one end to form an open ended turn, although other cross sections for the shield winding are also possible.

A secondary winding is utilized that matches the shield turn in common mode (CM) and differential mode (DM) swings, thus ‘bootstrapping’ it. A common mode swing is the average voltage change of the winding relative to local ground. A differential mode swing is the change in end-to-end voltage of a single winding. Since the voltage distributions are the same for the shield and the secondary winding, substantially close to zero capacitive noise current flows between them.

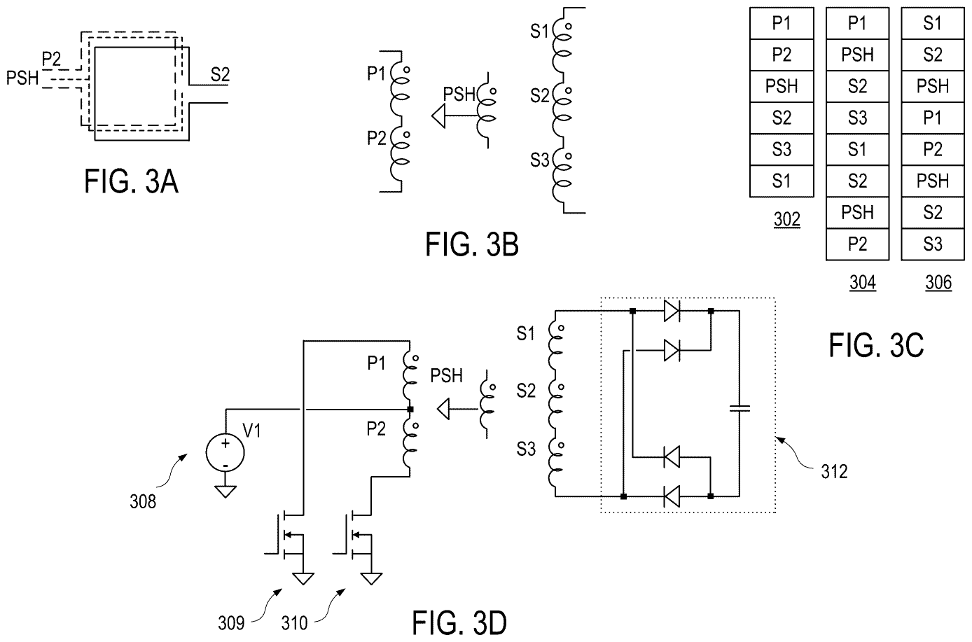

In some embodiments, matching the voltage distributions of the secondary winding and the shield winding may be accomplished adding a rectifier circuit to the circuit that includes the secondary winding. In the circuit diagram for an example transformer shown in FIG. 3D, the rectifier circuit 312 connects the two secondary windings on either end, S1 and S3. A rectifier circuit modifies an oscillating voltage profile into the absolute value of the oscillating voltage profile, effectively changing AC voltage oscillations to DC. In other words, the negative voltages are converted to equal magnitude positive voltages, and the positive voltages are left unchanged. In some embodiments, the rectifier circuit is a bridge rectifier circuit, or other types of rectifier circuits may be used, as desired.

Advantageously, since the secondary is bootstrapped to the shield, it is agnostic to the power topology of the primary, providing greater flexibility. Because the secondary winding is functional, it can have the same geometry and layout as the shield turn. Accordingly, there's no mirror image issues or recirculating current, and no extra dead layer as in the double shielded approach. The remaining secondary windings are ‘hidden’ behind the matching secondary winding.

Having the same layout for the shield and the secondary winding effectively avoids circulating capacitive currents with broadband low noise generation and an effective capacitance of less than one picofarad (pF).

### Example Transformer Architecture

The following paragraphs describe one specific example architecture for a half-bootstrapped, half-shielded power transformer, according to some embodiments.

Primary: current fed full bridge, 3T—Secondary: bridge sync rectified, 5T. A current fed topology operates with an input current, rather than a more traditional voltage input. The switch deadtime is generally a short circuit condition, rather than an open circuit condition in a voltage fed topology. Full bridge and bridge rectifier topologies use four switching elements in an ‘H’ configuration.

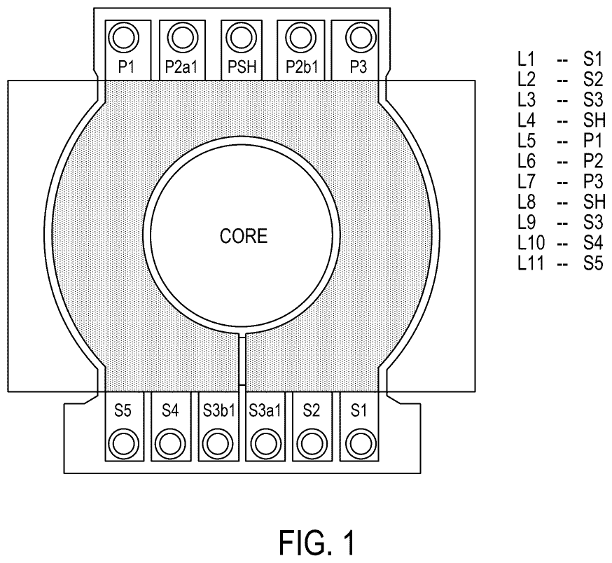

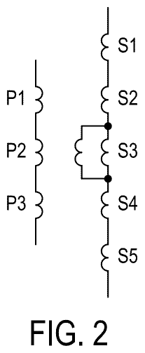

Since the primary winding is current fed, it has large common mode swings and it may not be effective for it to be directly bootstrapped. These common-mode swings result from the shorted deadtime condition, where the primary is momentarily shorted out before being driven with alternating polarity. Accordingly, a shield winding is employed on the primary winding. Since the secondary winding is bridge rectified, the center winding (S3) has a ‘virtual’ quiet node, and matches the voltage potential distribution of the shield winding. An example stack-up for this arrangement could be as follows:
S1|S2|S3|PSH|P3|P2|P1|PSH|S3|S4|S5,
where S1-S5 denote the five secondary windings, P1-P3 denote the three primary windings, and PSH denotes the primary shields. A top-down physical view of this transformer architecture and some of the electrical contacts of the windings is shown in FIG. 1, where the right hand side maps the different primary and secondary windings and the shields to the physical layers, {L1, L2, etc.}, of the transformer. FIG. 1 illustrates a top-down view that obscures some details of the intermediate layers, and is simply intended to convey a potential physical layout for the described embodiments. More detailed Figures that separately illustrate each layer are described in greater detail below. Note that the S3 winding is duplicated with two S3 windings connected in parallel on either side of the two primary shields. This is shown in FIG. 2, which illustrates the circuit connections between the different primary and secondary windings for the architecture shown in FIG. 1. This design implements multiple interleaving layers. Specifically, two are used in this architecture, each time S3 is adjacent to PSH.

Interleaving reduces leakage inductance and AC resistance but increases capacitance. Due to the noise reduction of this approach, that tradeoff is not as harmful as it would normally be, allowing for either {very low noise+moderate efficiency} or {low noise+high efficiency}

A combination of shielded and bootstrapped approach in a planar transformer format enables the following advantages. For some topologies (e.g., for a bridge primary/secondary), this allows the shield and bootstrap layers to be identical, which allows closer to ideal bootstrapping, reduction of noise currents, and lower noise. Not just the average voltage, but the distributed voltages along the winding should be the same, reducing circulating currents. In addition, compared to a purely shielded approach, described embodiments reduce the number of ‘dead’ copper layers in the stack-up to improve density and efficiency (i.e., by using only a primary shield, rather than both a primary and secondary shield).

The described embodiments are also more flexible and can be used in additional power topologies besides purely bootstrapped approaches. Pure bootstrapping approaches may not work for some topologies that have no inherently balanced windings, or with current-fed architectures where at least one set of windings has large common-mode swings.

While some embodiments are described as implemented in a printed circuit board (PCB) format, stamped metal windings, a mix of PCB/stamped metals/wiring, or other constructions are also possible, as desired. Variations on the PCB technology used could improve performance further. For example, via fencing or edge plating the perimeter of the shield or bootstrap windings could allow for even better shield coverage. Via fencing is a technique where a row of closely spaced vias surround a conductor to provide a discretized approximation of a shield in 3D space. Edge plating is a PCB process where the PCB board edge is plated with a conductive material, providing a continuous shield in 3D space.

In addition, windings may have only a single layer foil turn. This may provide simple construction and high performance. Alternatively, the windings may include multiple turns per layer, a discrete conductor, and so on, among other possibilities. A discrete conductor could be a conventional wire, forming a hybrid construction of planar and wire & bobbin techniques. Single layer foil turns for the shield and bootstrap/balance layers may provide the simplest and best performance.

### FIGS. 3-6—Planar Transformer Architectures

FIGS. 3-6 illustrate different circuit diagrams for planar transformers, according to various embodiments. The transformer circuit diagrams illustrated in FIGS. 3-6 are similar in some aspects to the transformer shown in FIG. 1, except that they differ in the number of primary windings, the number of secondary windings, and/or the number of secondary shields.

FIGS. 3A-D illustrate aspects of a 2:3 variant (i.e., two primary windings and three secondary windings) of a planar transformer, according to some embodiments. FIG. 3A illustrates a top view of the physical arrangement for the S2 secondary winding, the primary shield (PSH), and a primary winding (Px) for one example transformer. FIG. 3A shows how the S2 layer and the PSH layer have the same arrangement of a “C” shape, whereas the Px layer has a C shape that is rotated 180 degrees relative to S2 and PSH. The layers are illustrated with a slight offset for better visibility, although in actuality they are stacked directly on top of each other. Note that the magnetic core of the transformer, which is located in the interior of the C shapes, is not shown.

FIG. 3B illustrates the PSH connected to ground to shunt current and positioned between the primary and second windings.

FIG. 3C illustrates three variants of possible layer stacks to construct a transformer, according to various embodiments. The layer stack 302 has the two primary windings stacked on top of the PSH, which is stacked on top of the three secondary windings (i.e., with no interleaving). The layer stack 304 has the secondary windings in the middle of the stack with a duplicated S2 layer on either side (where the two S2 layers are connected in parallel), with two PSH layers on either side of the secondary windings, and the 2 primary windings outside of the two PSH layers. Finally, the layer stack 306 illustrates an inverse arrangement with the primary windings in the center and the secondary windings on either side of the PSH layers, again with two S2 layers connected in parallel and adjacent to the PSH layers.

FIG. 3D is a more detailed circuit diagram for the 2:3 transformer. FIG. 3D illustrates the driving voltage V1 (308) for the primary windings, and the two connections to ground (309, 310) for each primary winding. Other power topologies may also be used, as desired. FIG. 3D also illustrates a rectifier circuit 312 (encased in a dashed-line box) which is connected to the S1 and S3 windings.

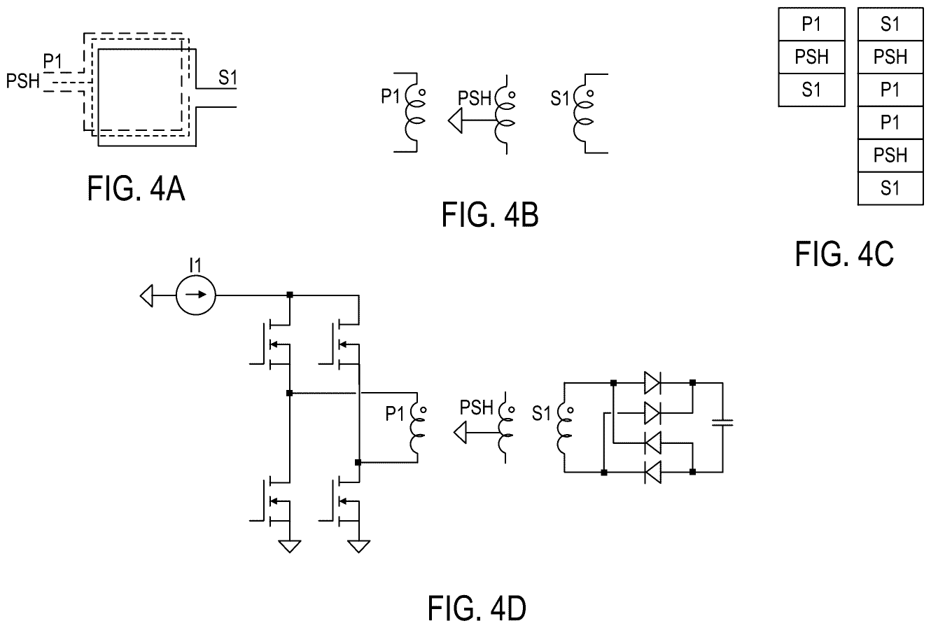

FIGS. 4A-D is a set of diagrams similar in some aspects to FIGS. 3A-D, which describes aspects of a 1:1 variant of a planar transformer (i.e., with one primary winding and one secondary winding).

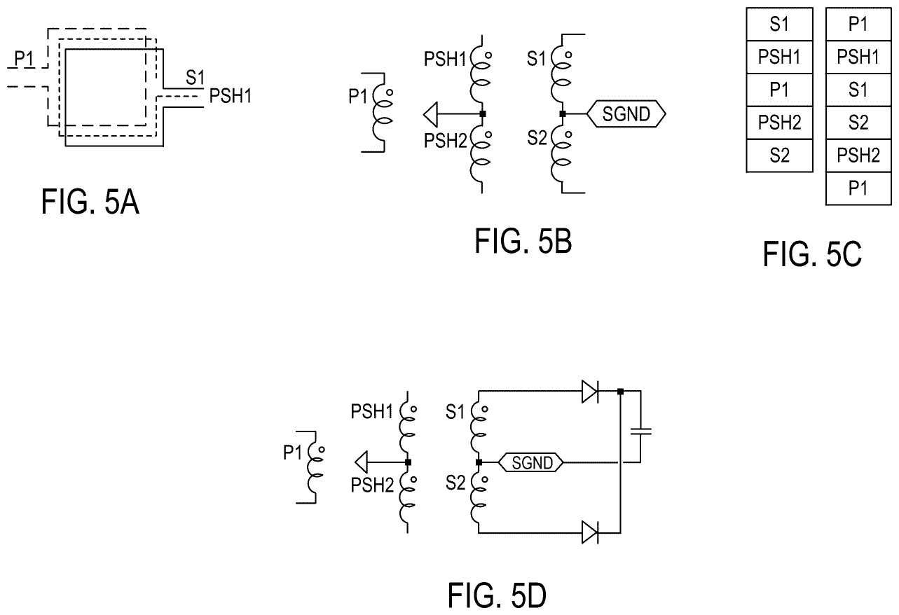

FIGS. 5A-D is a set of diagrams similar in some aspects to FIGS. 3A-D, which describes aspects of a 1:2 variant of a planar transformer (i.e., with one primary winding and two secondary windings). Note that FIGS. 5A-D illustrate center-tapped secondary windings, although other topologies may also used, as desired.

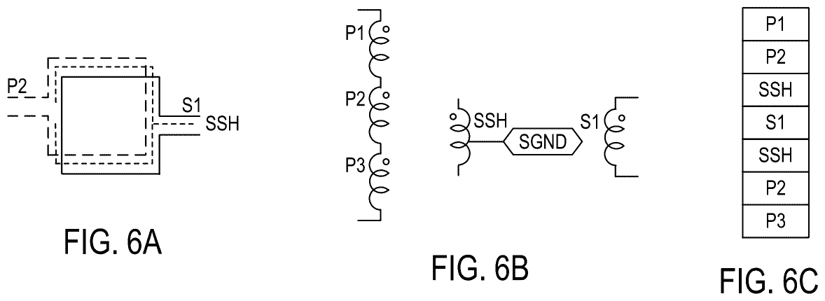

FIGS. 6A-C is a set of diagrams similar in some aspects to FIGS. 3A-C, which describes aspects of a 3:1 variant of a planar transformer (i.e., with three primary windings and one secondary winding).

Some embodiments describe a planar transformer that includes a core, a first circuit including two or more primary windings, a second circuit including two or more secondary windings, and a primary conductive shield stacked between one of the primary windings (referred to as the “first” primary winding) and one of the secondary windings referred to as the “first” secondary winding). In some embodiments, the primary conductive shield reduces a capacitive coupling between the first primary winding and the first secondary winding.

In some embodiments, the primary windings are magnetically coupled to the core and the secondary windings are magnetically coupled to the core and a rectifier circuit. The rectifier circuit may be a bridge rectifier, or another type of rectifier circuit.

In some embodiments, the two or more primary windings are stacked in two or more layers, wherein each primary winding is in a separate layer. One example layout, as shown in FIG. 1, includes three primary windings in the center of a layer stack and flanked on either side by a primary shield winding. The secondary windings are then stacked on either side, outside the two primary shield windings.

In some embodiments, the bridge rectifier circuit modifies a first voltage profile of the first secondary winding to correspond to a second voltage profile of the primary conductive shield.

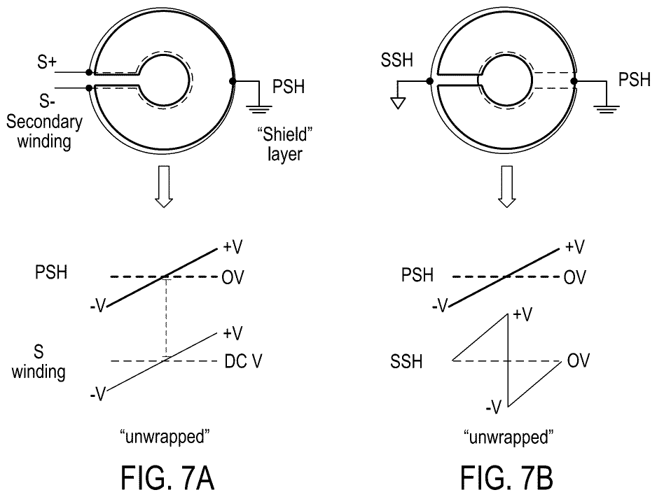

In some embodiments, the primary conductive shield and the first secondary winding form a “C” shape around the core, where the two “C” shapes are aligned with each other (i.e., so that the opening of the “C” are pointed in the same direction). This arrangement is illustrated in FIG. 7A. The bottom half of FIG. 7A illustrates the unwrapped voltage profiles for the PSH layer and the secondary winding layer, which are aligned with each other. This contrasts with the voltage profiles for a typical dual-shielded arrangement, which is shown in FIG. 7B for a primary shield (PSH) and a secondary shield (SSH). The C shapes of the two shield layers are rotated 180 degrees with respect to each other, leading to an unaligned voltage profile and voltage discontinuity that may result in undesired capacitive coupling and sensitivity to fringing effects.

In some embodiments, another secondary winding is stacked adjacent to the first secondary winding on the opposite side from the primary conductive shield. In other words, the layer stack may be {primary winding, primary shield, first secondary winding, second secondary winding}.

In some embodiments, the two or more secondary windings include an odd number of secondary windings. Having an odd number of secondary windings may advantageously cause the middle secondary winding to naturally have a ‘virtual’ quiet node that matches the voltage potential distribution of the shield winding.

In some embodiments, the secondary windings include a second secondary winding connected in parallel to the first secondary winding (e.g., the two S3 windings shown in FIGS. 1 and 2). In these embodiments, the planar transformer may further include a second primary conductive shield stacked between a “second” primary winding and the second secondary winding. The second primary conductive shield reduces a capacitive coupling between the second primary winding and the second secondary winding. In some embodiments, these first and second primary windings are positioned in an uppermost and lowermost layer of the two or more layers of primary windings.

In some embodiments, the two or more primary windings are electrically connected in a first series connection, and the two or more secondary windings are electrically connected in a second series connection.

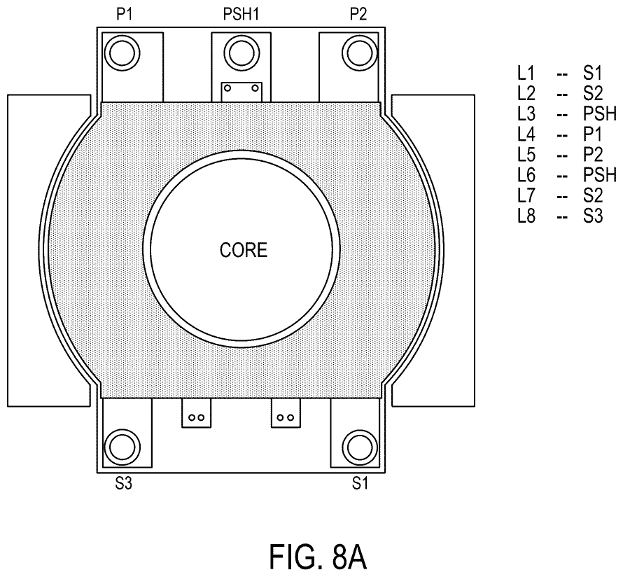

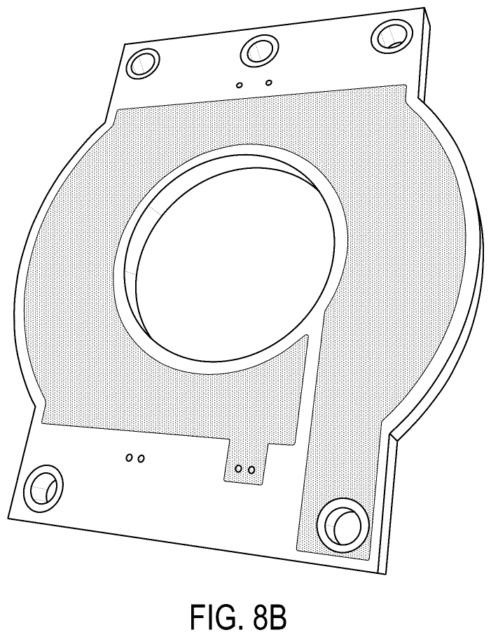

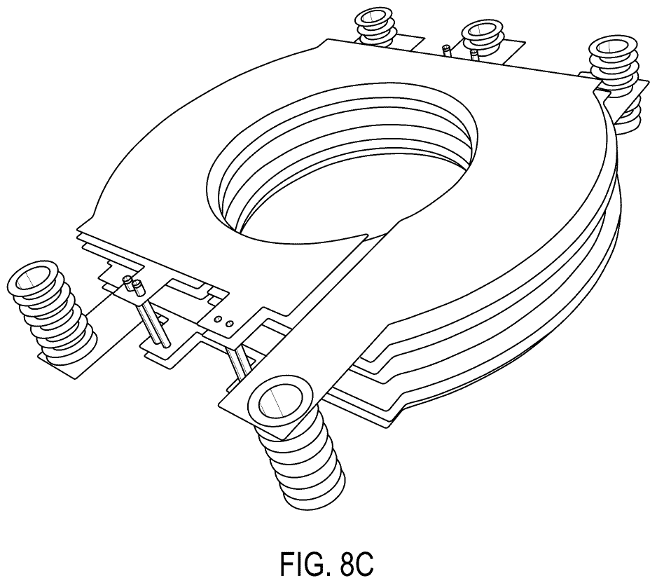

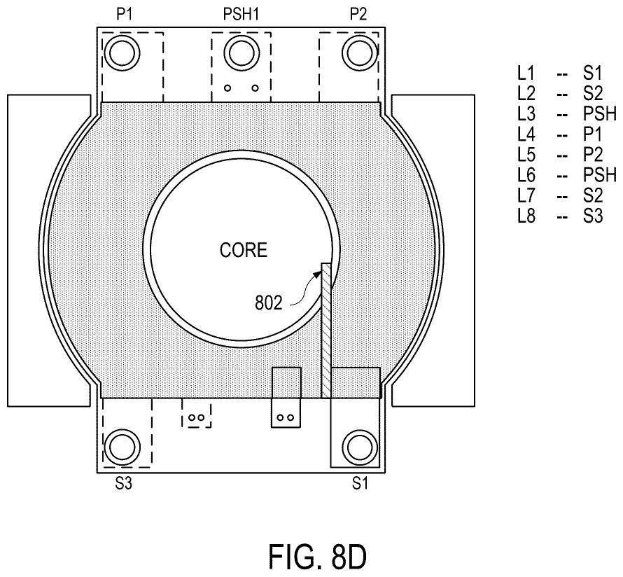

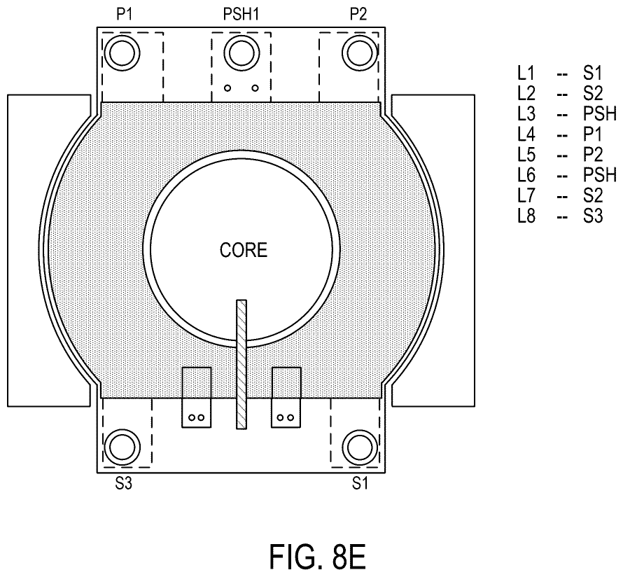

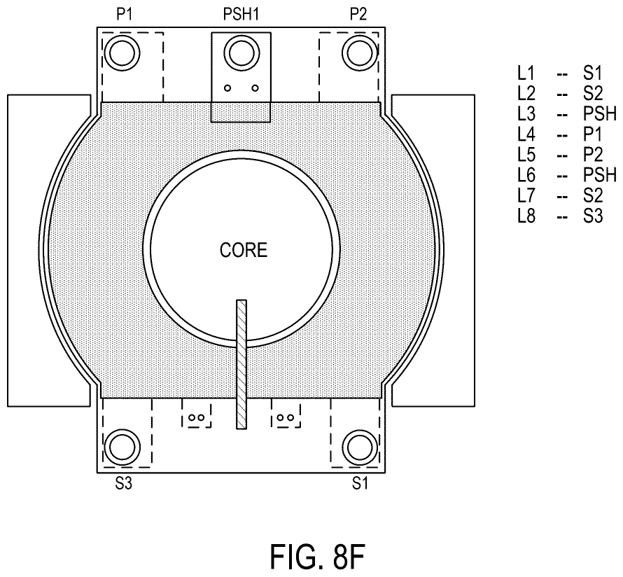

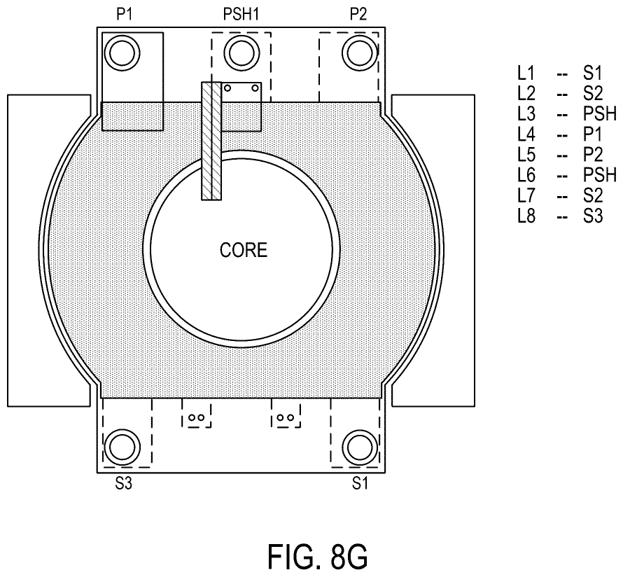

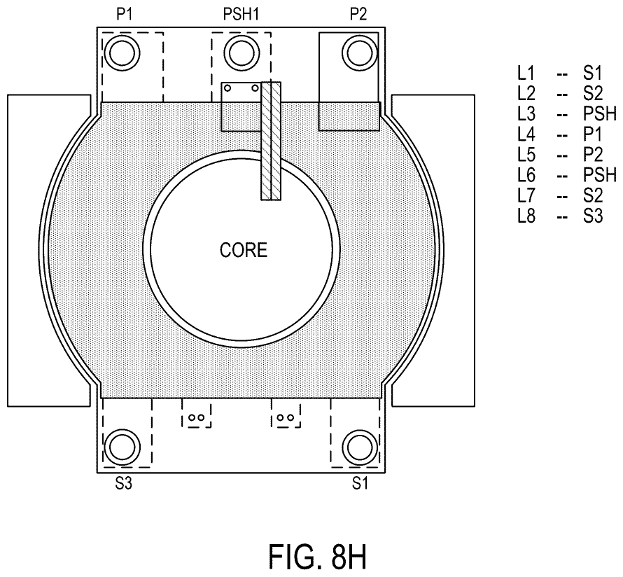

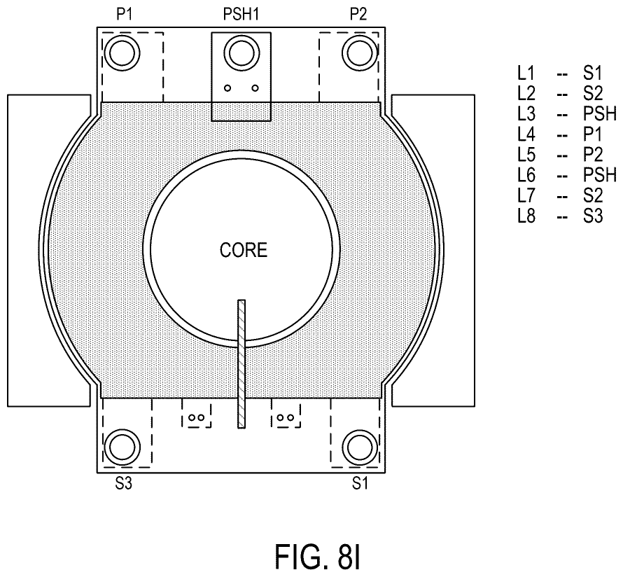

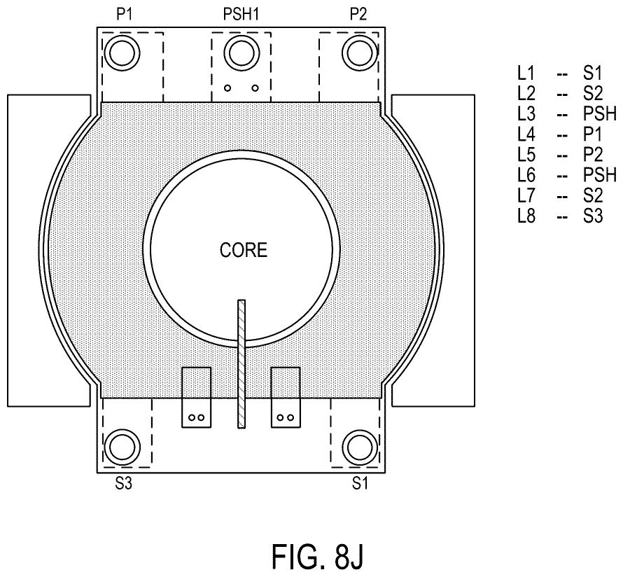

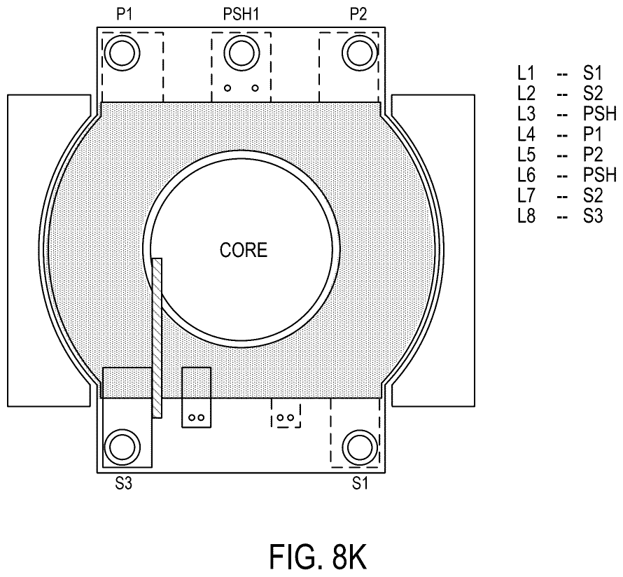

### FIGS. 8A-K —Detailed Physical Layout for 2:3 Planar Transformer

FIGS. 8A-K illustrate detailed physical aspects of a 2:3 planar transformer design, according to some embodiments. FIG. 8A illustrates A top down view of the transformer, with the 8 layer stacks {L1, L2, etc.} identified on the left-hand side. FIG. 8B illustrates the same transformer from an isometric view, and FIG. 8C is an exploded image of the copper layers of the transformer. FIGS. 8D-K separately illustrate each of the 8 layers of the 2:3 planar transformer. Each of FIGS. 8D-K illustrates where either end of the respective windings attach to the electrical contacts on the top or bottom of the figures. In FIGS. 8D-K, the diagonally hashed rectangles (e.g., 802 in FIG. 8D) illustrate an insulating material that electrically isolates the two sides of the winding.

Although the embodiments above have been described in considerable detail, numerous variations and modifications will become apparent to those skilled in the art once the above disclosure is fully appreciated. It is intended that the following claims be interpreted to embrace all such variations and modifications. Furthermore, note that the word “may” is used throughout this application in a permissive sense (e.g., having the potential to, being able to), not a mandatory sense (e.g., must). The term “include,” and derivations thereof, mean “including, but not limited to.” As used in this specification, the singular forms “a,” “an,” and “the” include plural referents unless the content clearly indicates otherwise. Thus, for example, reference to “a device” includes a combination of two or more devices.

What is claimed is:

1. A planar transformer, comprising:
a core;
a first circuit comprising two or more primary windings that are magnetically coupled to the core, wherein the two or more primary windings are stacked in two or more layers;
a second circuit comprising two or more secondary windings that are magnetically coupled to the core and a rectifier circuit; and
a primary conductive shield stacked between a first primary winding of the two or more primary windings and a first secondary winding of the two or more secondary windings, wherein the primary conductive shield reduces a capacitive coupling between the first primary winding and the first secondary winding.

2. The planar transformer of claim 1,
wherein the rectifier circuit modifies a first voltage profile of the first secondary winding to correspond to a second voltage profile of the primary conductive shield.

3. The planar transformer of claim 1,
wherein the primary conductive shield forms a first “C” shape around the core, and
wherein the first secondary winding forms a second “C” shape around the core, wherein the second “C” shape that overlaps the first “C” shape.

4. The planar transformer of claim 1,
wherein a second secondary winding of the two or more secondary windings is stacked adjacent to the first secondary winding on an opposite side of the first secondary winding as the primary conductive shield.

5. The planar transformer of claim 1,
wherein the two or more secondary windings include an odd number of secondary windings.

6. The planar transformer of claim 1,
wherein the two or more secondary windings comprise a second secondary winding connected in parallel to the first secondary winding, wherein the planar transformer further comprises:
a second primary conductive shield stacked between a second primary winding of the two or more primary windings and the second secondary winding, wherein the second primary conductive shield reduces a capacitive coupling between the second primary winding and the second secondary winding.

7. The planar transformer of claim 6,
wherein the first and second primary windings are positioned in an uppermost and lowermost layer of the two or more layers.

8. The planar transformer of claim 1,
wherein the two or more primary windings are electrically connected in a first series connection, and
wherein the two or more secondary windings are electrically connected in a second series connection.

9. The planar transformer of claim 1,
wherein the rectifier circuit comprises a bridge rectifier circuit.

10. A planar transformer, comprising:
a core;
a first circuit comprising two or more secondary windings that are magnetically coupled to the core, wherein the two or more secondary windings are stacked in two or more layers;
a second circuit comprising two or more primary windings that are magnetically coupled to the core and a rectifier circuit; and
a secondary conductive shield stacked between a first primary winding of the two or more primary windings and a first secondary winding of the two or more secondary windings, wherein the secondary conductive shield reduces a capacitive coupling between the first primary winding and the first secondary winding.

11. The planar transformer of claim 10,
wherein the rectifier circuit modifies a first voltage profile of the first primary winding to correspond to a second voltage profile of the secondary conductive shield.

12. The planar transformer of claim 10,
wherein the secondary conductive shield forms a first “C” shape around the core, and
wherein the first primary winding forms a second “C” shape around the core, wherein the second “C” shape that overlaps the first “C” shape.

13. The planar transformer of claim 10,
wherein a second primary winding of the two or more primary windings is stacked adjacent to the first primary winding on an opposite side of the first primary winding as the secondary conductive shield.

14. The planar transformer of claim 10,
wherein the two or more primary windings include an odd number of primary windings.

15. The planar transformer of claim 10,
wherein the two or more primary windings comprise a second primary winding connected in parallel to the first primary winding, wherein the planar transformer further comprises:
a second secondary conductive shield stacked between a second secondary winding of the two or more secondary windings and the second primary winding, wherein the second secondary conductive shield reduces a capacitive coupling between the second primary winding and the second secondary winding.

16. The planar transformer of claim 15,
wherein the first and second secondary windings are positioned in an uppermost and lowermost layer of the two or more layers.

17. The planar transformer of claim 10,
wherein the two or more primary windings are electrically connected in a first series connection, and
wherein the two or more secondary windings are electrically connected in a second series connection.

18. The planar transformer of claim 10,
wherein the rectifier circuit comprises a bridge rectifier circuit.
